(19) United States
(12) Patent Application Publication
(10) Pub. No.: US 2008/0138139 A1
(43) Pub. Date: Jun. 12, 2008

(54) CAPLESS WRITING TOOL

(75) Inventor: Hidehei Kageyama, Kawagoe-shi (JP)

Correspondence Address: ROTHWELL, FIGG, ERNST & MANBECK, P.C., 1425 K STREET, N.W., SUITE 800, WASHINGTON, DC, 20005, US

(73) Assignee: KOTOBUKI & CO., LTD., Kawagoe-shi (JP)

(21) Appl. No.: 11/608,290

(22) Filed: Dec. 8, 2006

(51) Int. Cl. B43K 7/12; B43K 24/02

(52) U.S. Cl. 401/108; 401/107

(57) ABSTRACT

A capless writing tool comprising a refill adapted to slide longitudinally through the interior of a barrel, an inner tube adapted to move through the interior of the barrel together with the refill, and a lid mounted pivotably in a front portion of the inner tube to open and close a front opening of the inner tube, the lid having a retaining projection for engagement with the barrel or a front piece.

### BACKGROUND OF THE INVENTION

### Field of the Invention

The present invention relates to what is called a capless writing tool provided with writing means and an opening/closing lid, the writing means using volatile ink such as marker, sign pen, or rectifying liquid.

In conventional like writing tools, the lid opening/closing operations are not smooth and are uncertain and there has been a fear of drying of the writing means due to imperfect sealing of the writing tool caused, for example, by the adhesion of ink to the lid (see Patent Literature 1).

### [Patent Literature 1]

Japanese Utility Model Laid-Open No. Hei 5 (1993)-49382

### SUMMARY OF THE INVENTION

Problems to be solved by the present invention are uncertainty of the lid opening/closing operations, imperfect sealing of the writing body caused by the adhesion of ink to the lid, and drying of the writing means.

According to the present invention there is provided a capless writing tool comprising a refill adapted to slide longitudinally through the interior of a barrel, an inner tube adapted to move through the interior of the barrel together with the refill, and a lid mounted pivotably in a front portion of the inner tube to open and close a front opening of the inner tube, the lid having a retaining projection for engagement with the barrel or a front piece, whereby the lid opening/closing operations can be done positively in interlock with a knocking operation. This is a main characteristic of the present invention.

In the capless writing tool of the present invention, the lid is provided pivotably for opening and closing through a pivot shaft connected pivotally to the inner tube, and the retaining projection of the lid, which projection has a retaining pawl, is engaged with a retaining portion formed on a side face of the barrel or the front piece, whereby it provides an advantage that the lid opening/closing operations can be done positively and interlockedly with a knocking operation in a one-touch manner.

Thus, the lid is provided pivotably for opening and closing through a pivot shaft connected pivotally to the inner tube and the retaining projection of the lid having a retaining pawl is engaged with the retaining portion formed on a side face of the barrel or the front piece, thereby permitting positive opening/closing operations of the lid.

### BRIEF DESCRIPTION OF THE DRAWINGS

FIG. 1 is a longitudinal sectional view of a capless writing tool according to a first embodiment of the present invention, showing an accommodated state of writing means;

FIG. 2 is a longitudinal sectional view of the capless writing tool of the first embodiment, showing a projected state of the writing means;

FIG. 3 is an enlarged sectional view of a principal portion of the capless writing tool of the first embodiment, showing a closed state of a lid;

FIG. 4 is an enlarged sectional view of the principal portion of the capless writing tool of the first embodiment, showing an opened state of the lid;

FIG. 5 is an enlarged sectional view of a principal portion of a capless writing tool according to a modification of the first embodiment;

FIG. 6 is an enlarged sectional view of a principal portion of a capless writing tool according to another modification of the first embodiment;

FIG. 7 is a longitudinal sectional view of a capless writing tool according to a second embodiment of the present invention, showing an accommodated state of writing means;

FIG. 8 is an enlarged sectional view of a principal portion of the capless writing tool of the second embodiment, showing an accommodated state of the writing means;

FIG. 9 is an enlarged sectional view of the principal portion of the capless writing tool of the second embodiment, showing a projected state of the writing means;

FIG. 10 is a longitudinal sectional view of a capless writing tool according to a third embodiment of the present invention, showing an accommodated state of writing means;

FIG. 11 is a bottom view of the capless writing tool of the third embodiment, showing an accommodated state of the writing means;

FIG. 12 is an enlarged sectional view of a principal portion of the capless writing tool of the third embodiment, showing a closed state of a lid;

FIG. 13 is a longitudinal sectional view of the capless writing tool of the third embodiment, showing a projected state of the writing means; and

FIG. 14 an enlarged sectional view of a principal portion of the capless writing tool of the third embodiment, showing an opened state of a lid.

### DETAILED DESCRIPTION OF PREFERRED EMBODIMENTS

### First Embodiment

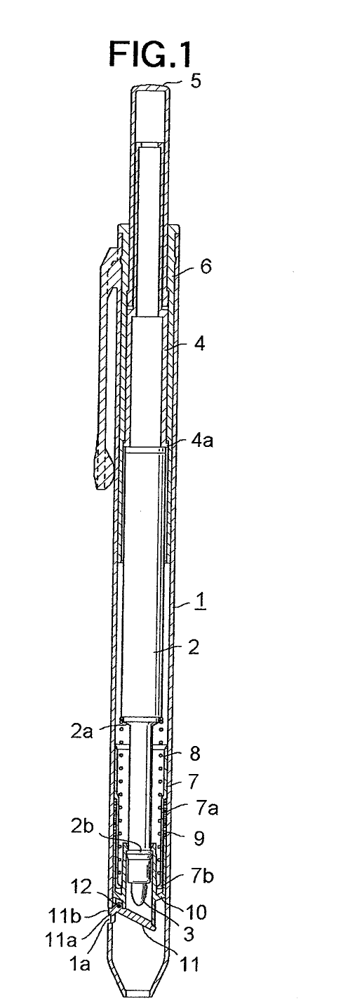

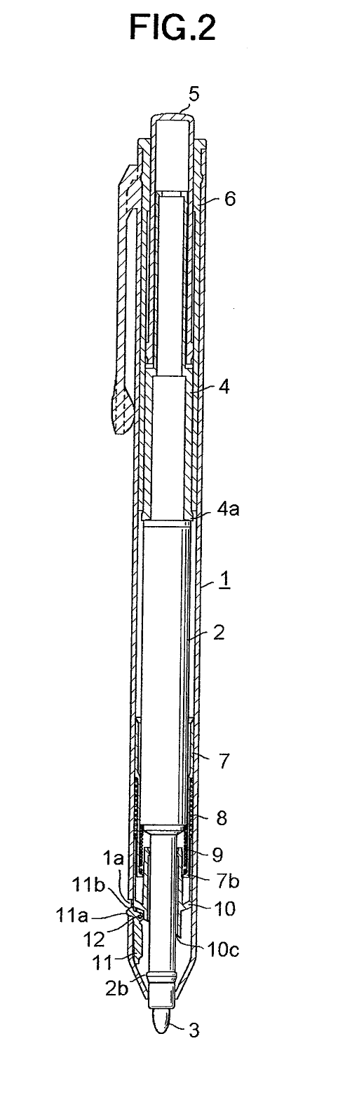

FIGS. 1 and 2 are longitudinal sectional views of a capless writing tool according to a first embodiment of the present invention. FIG. 1 shows an accommodated state of writing means and FIG. 2 shows a projected state of the writing means, ready for writing. In the figures, the capless writing tool is constituted by a barrel 1 which is what is called a single shaft integral with a front body. A refill 2 filled with volatile ink is accommodated slidably in a longitudinal direction within the barrel 1. Attached to a front end of the refill 2 is a front end tip 3 as writing means from which ink is fed.

A known rotary cam 4 is in abutment against a rear end of the refill 2 and a knocking cam 5 to be knocked is engaged with a rear portion of the rotary cam 4. A plastic tail cap 6 is disposed between the barrel 1 and those cams. More specifically, the tail cap 6 is fixed to the interior of a rear portion of the barrel 1. In the inner periphery of the tail cap 6 is formed a cam groove with which a front projection 4a of the rotary cam 4 is engaged and guided.

Further, a stopper tube 7 serving as a stopper is fixed to the inner periphery of a front portion of the barrel 1 in the writing tool. A front portion of the stopper tube 7 is formed as a reduced-diameter portion 7a and an inner flange 7b is formed at a front end of the stopper 7. A return spring 8 is disposed between the inner flange 7b and a stepped portion 2a of the refill 2, urging the refill 2 backward constantly. On the other hand, an actuating spring 9 is wound round the outside of the reduced-diameter portion 7a of the stopper tube 7. A front end of the actuating spring 9 is abutted against a rear end of an outer periphery wall 10b of an inner tube 10 and urges the inner tube 10 forward constantly.

The inner tube 10 comprises an inner periphery wall 10a and an outer periphery wall 10b connected to the inner periphery wall 10a, with a slant opening 10c being formed in a front face of the inner periphery wall 10a. The inner periphery wall 10a of the inner tube 10 which forms the slant opening 10c is cut obliquely toward a retaining portion 1a and a rib 10d is formed inside a rear end portion of the inner periphery wall 10a. The rib 10d is engaged with a retaining lug 2b formed on the outer periphery of a front portion of the refill 2.

A description will now be given about an opening/closing lid 11 which opens and closes the slant opening 10c of the inner tube 10. The lid 11 is mounted pivotably through a pivot shaft 12 connected pivotally to the inner tube 10. When the lid 11 closes the opening 10c of the inner tube 10, an upper end portion of the lid 11 is engaged with a rear end of the retaining portion 1a of the barrel 1. More specifically, a bent retaining projection 1a of the lid 11 has a retaining pawl 11b facing backward and lies within the retaining portion 1a of the barrel 1. When the refill 2 is knocked, the retaining pawl 11b at the rear end of the retaining portion 1a is released and the front end tip 3 as writing means projects.

The following description is now provided about the operation of the capless writing tool of this embodiment.

First, when a rear end of the knock cam 5 is knocked to actuate the cam mechanism, the refill 2 moves forward. With this forward movement of the refill 2, the inner tube 10 which has been pressed by the retaining lug 2b formed on the front side of the refill 2 moves forward together with the refill 2 by virtue of a repulsive force of the actuating spring 9. As a result, since the inner tube 10 also moves forward together with the forward movement of the refill 2, the retaining projection 11a formed on the lid 11 and having the retaining pawl 11b comes into abutment against a front end face of the retaining portion 1a of the barrel 1, causing the lid 11 to spring up pivotally about the pivot shaft 12, whereby the lid 11 can be opened positively. In this writing condition, the inner tube 10 is in a forwardly pushed state constantly by the spring 9, so that the lid 11 is open.

On the other hand, when the refill 2 is to be retracted, the refill 2 moves backward, so that the retaining lug 2b formed on the front side of the refill 2 comes into engagement with the rib 10d formed on the inner tube 10 and the inner tube 10 also moves backward together with the movement of the refill 2. As a result, the retaining projection 11a of the lid 11 comes into abutment against a rear end face of the retaining portion 1a of the barrel 1, whereby the slant opening 10c formed in the front end of the inner tube 10 can be sealed positively with the pivot shaft 12 as fulcrum. That is, the retaining lug 2b formed on the front side of the refill 2 comes into engagement with the rib 10d formed on the inner tube 10 to effect sealing at this portion and thus a sealed space can be ensured in cooperation with the lid 11.

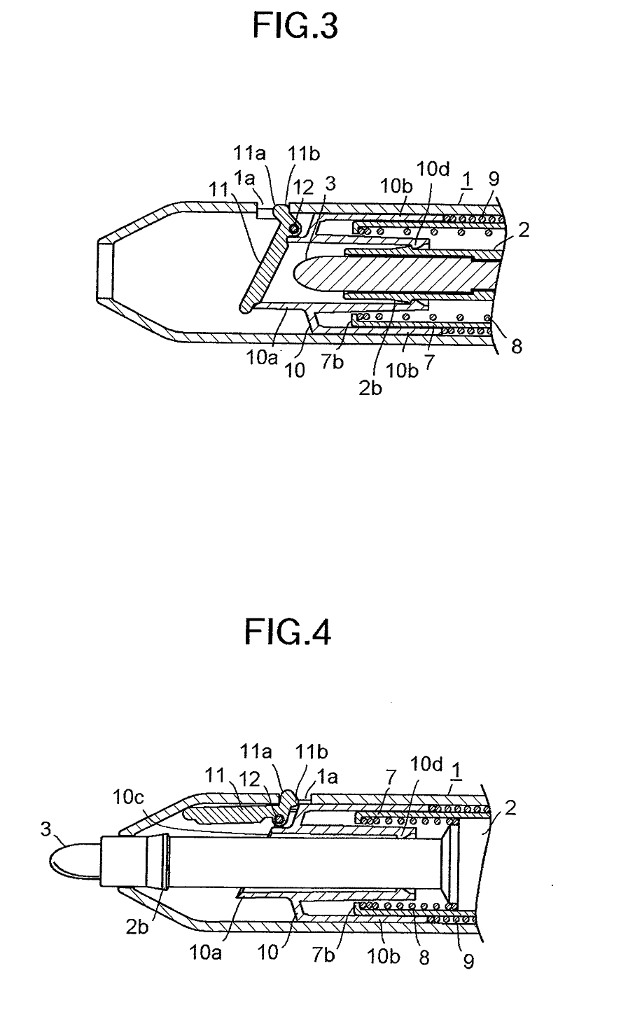

From FIG. 3 it is seen that the inner tube 10 retreats with retreat of the refill 2 and that the retaining projection 11a of the lid is put in abutment against the rear end face of the retaining portion formed on the side wall of the barrel 1, resulting in the lid 11 pivoting about the pivot shaft 12 and being closed forcibly.

From FIG. 4 it is seen that the front portion of the inner tube 10 is internally chamfered and that by combination of this chamfered portion with the tapered portion of the lid 11, it is possible to seal in a more positive manner.

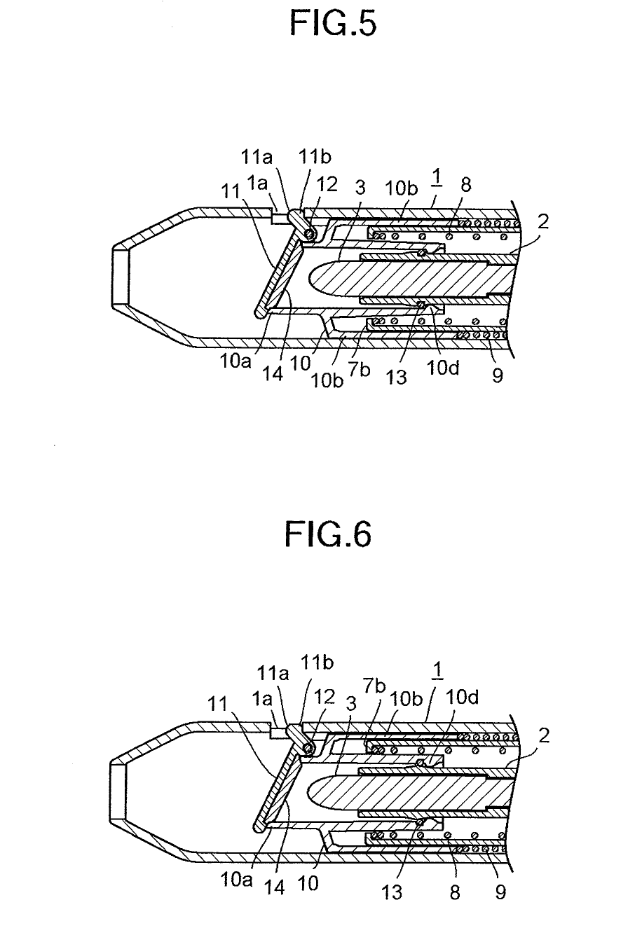

FIG. 5 shows a capless writing tool according to a modification of the first embodiment. As shown in the same figure, an end portion of the lid 11 or the inner tube 10 is formed using a soft member 14. Further, an O-ring 13 is inserted between an annular groove formed in the outer periphery of the refill 2 and the inner periphery wall 10a of the inner tube 10, whereby sealing can be effected more positively.

FIG. 6 shows a capless writing tool according to another modification of the above embodiments. As shown in the same figure, by engagement of the retaining lug 2b formed on the refill 2 with the rib 10d formed on the inner tube 10, the inner tube 10 can also retreat with retreat of the refill 2, thereby exhibiting a sealing effect. In this example, unlike the example shown in FIG. 5, an O-ring is fitted in an annular groove formed inside the inner periphery wall 10a of the inner tube 10.

Further, the contact portion between a front end face of the inner periphery wall 10a of the inner tube 10 and the lid 11 may be tapered, whereby the sealing effect can be enhanced to a greater extent.

Additionally, by using the soft member 14 on the surface of the lid 11 combined with the inner tube 10, it is possible to further enhance the sealing effect.

Conversely, also by providing the soft member at the front end portion of the inner tube 10, it is possible to attain the same sealing effect as above.

Since the lid 11 can be opened and closed without direct abutment of the front end tip 3 as writing means against the lid 11, it is possible to completely prevent imperfect sealing caused by the adhesion of ink to the lid 11 and drying of the writing means.

### Second Embodiment

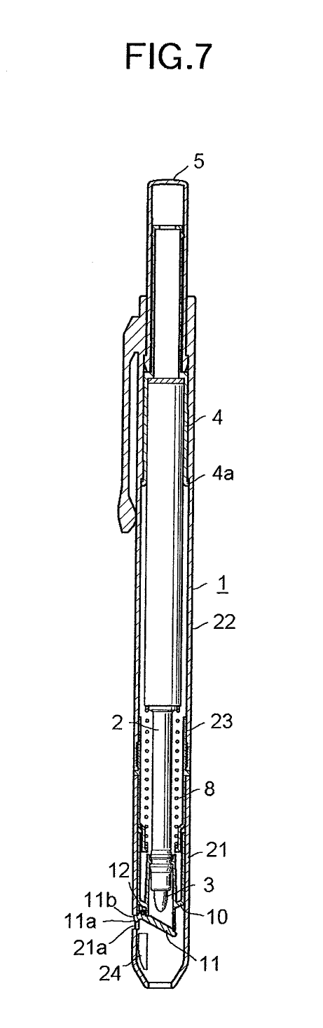

Next, FIGS. 7 to 9 show a capless writing tool according to a second embodiment of the present invention. In these figures, a barrel 1 comprises a front shaft 21 and a rear shaft 22, which are connected together through a mid-screw 23 serving as a stopper. The inner periphery of a front end of the rear shaft 22 is internally threaded and an externally threaded portion of the mid-screw 23 is threadedly engaged with the internally threaded portion of the rear shaft 22. The mid-screw 23 and the front shaft 21 are mounted by fitting. The front shaft 21 and the rear shaft 22 are connected together with an annular rib 23a of the mid-screw 23 interposed therebetween.

A window hole 24 for receiving the lid 11 therein is formed in a side wall of the front shaft 21. The window hole 24 is formed as a relief hole lest the lid 11 should come into abutment against the inner wall of front shaft 21 and contaminate the inner wall. Unlike the first embodiment, the capless writing tool of this second embodiment is not provided with tail cap, actuating spring and stopper tube, but the operation thereof is the same as in the first embodiment.

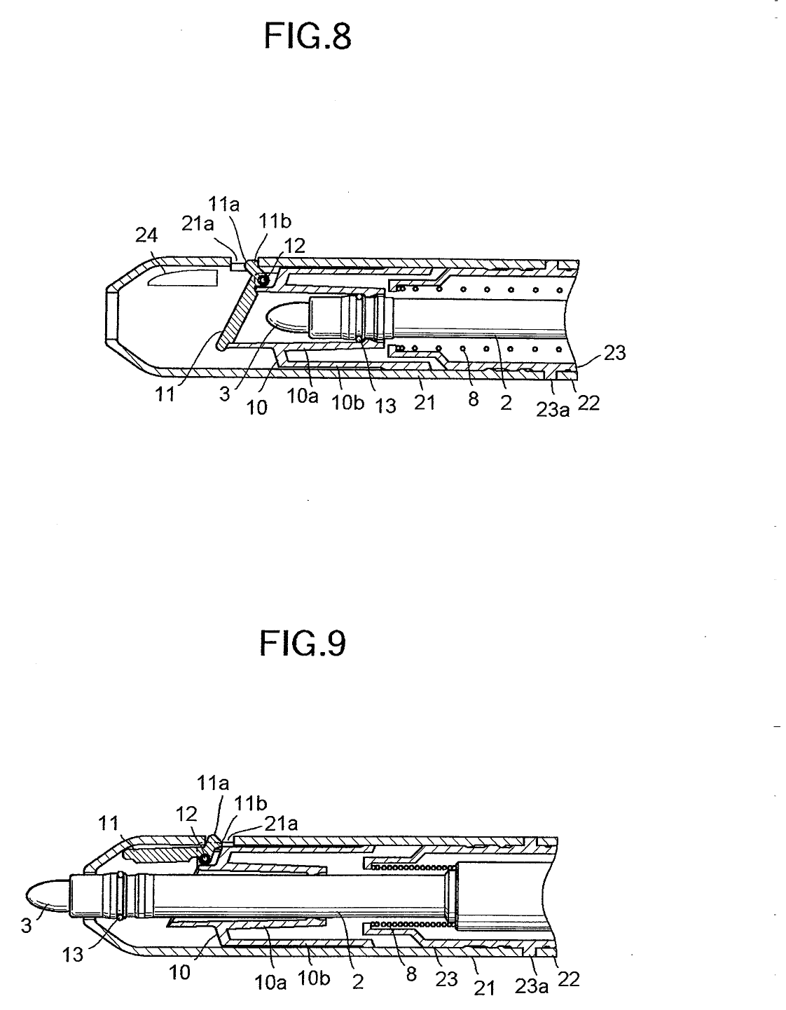

FIG. 8 shows a state in which the lid 11 closes the front opening of the inner tube 10. In this state, the projection 11a of the lid 11 is in abutment against a rear end of a retaining hole 21a of the front shaft 21 and the window hole 24 is not closed. Next, when the knocking cam 5 is knocked and the refill 2 is moved forward, the lid 11 is also moved forward and the projection 11a moves forward through the interior of the retaining hole 21a and is abutted and engaged with a front end of the retaining hole 21a, so that the lid 11 pivots about the pivot shaft 12 and is pushed up into the window hole 24. Consequently, the writing means is projected from a front-end opening of the front shaft 21. In this case, since the front end tip 3 passes and advances after opening of the lid 11, the lid 11 is not contaminated by the front end tip 3. Even if the lid 11 itself is contaminated, the front shaft 21 itself is not contaminated because the lid is received within the window hole 24. This an advantage of this construction.

Although in the above embodiment references have been made to an example of a rear-end knocking operation using a rotating mechanism as the delivery operation for the writing means, another method for the delivery operation may be adopted. In the case where a front piece is threadedly engaged with the barrel separately from the barrel, a through hole for engagement with the projection of the lid may be formed in a side wall of the front piece.

### Third Embodiment

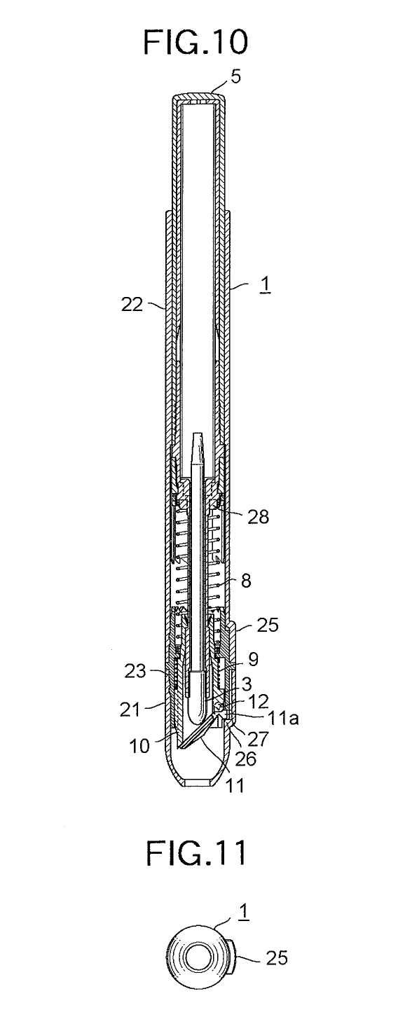

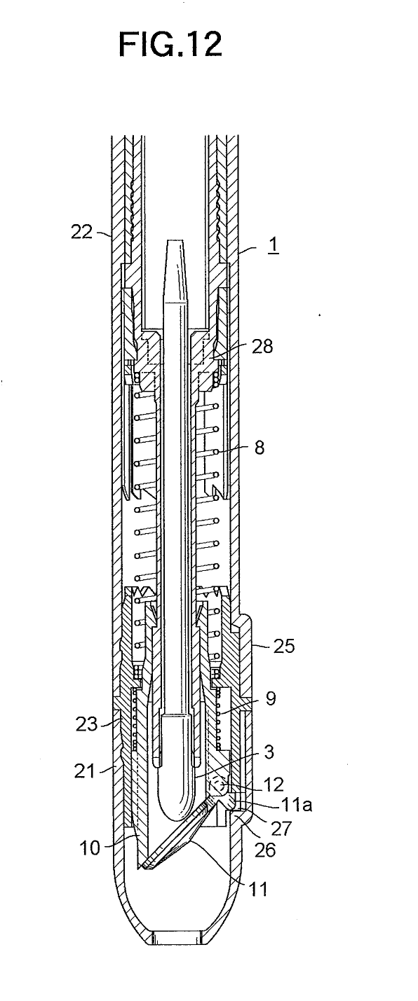

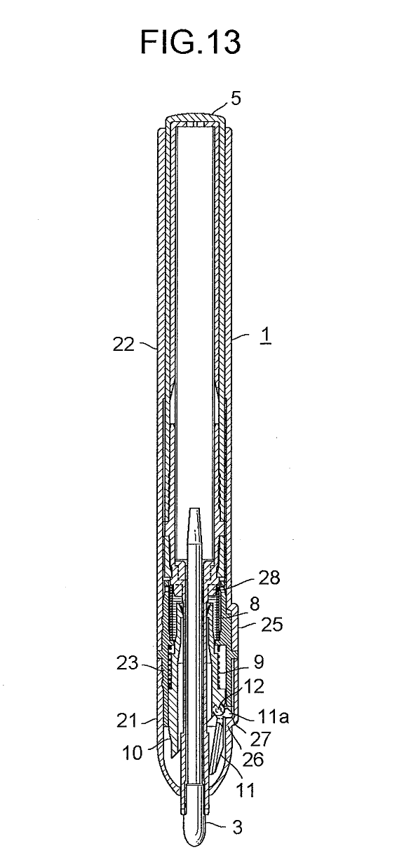

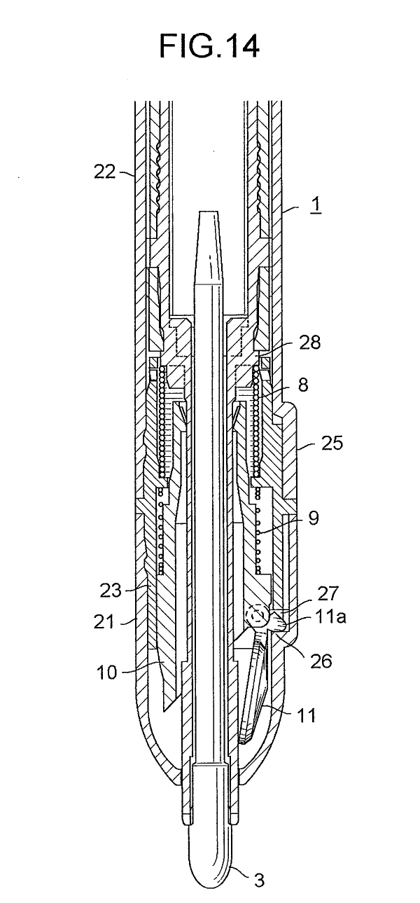

Next, FIGS. 10 to 14 show a capless writing tool according to a third embodiment of the present invention. In these figures, a barrel 1 comprises a front shaft 21 and a rear shaft 22, which are connected together through a mid-screw serving as a stopper. More specifically, the inner periphery of a front end of the rear shaft 22 is internally threaded and an externally threaded portion of the mid-screw 23 is threadedly engaged with the internally threaded portion of the rear shaft 22. The mid-screw 23 and the front shaft 21 are mounted by fitting. The front shaft 21 and the rear shaft 22 are connected together with an annular rib 23a of the mid-screw 23 interposed therebetween.

As is seen from FIG. 11, a part of a side wall of the front shaft 21 has an outwardly bulged portion 25 and a gap 27 serving as a retaining portion is formed between a stepped portion 26 of the bulged portion 25 and a front end of the mid-screw 23. The retaining projection 11a of the lid 11 pivotally supported by the inner tube 10 projects into the gap 27, whereby a stopper function is exhibited when the lid 11 is opened or closed. In the drawings, the reference numeral 28 denotes a guide pipe for guiding the front end tip 3.

What is claimed is:

1. A capless writing tool comprising:
a refill adapted to slide longitudinally through the interior of a barrel;
an inner tube adapted to move through the interior of said barrel together with said refill; and
a lid mounted pivotably in a front portion of said inner tube to open and close a front opening of the inner tube, said lid having a retaining projection for engagement with said barrel or a front piece.

2. The capless writing tool according to claim 1, wherein said barrel comprises a front shaft and a rear shaft, said front shaft and said rear shaft being connected together through a mid-screw, said mid-screw serving also as a stopper.

3. The capless writing tool according to claim 1, wherein an O-ring is interposed between said refill and an inner periphery wall of said inner tube.

4. The capless writing tool according to claim 1, wherein the surface of said lid combined with said inner tube is formed by a soft member.

5. The capless writing tool according to claim 1, wherein a soft portion is provided at a front end portion of said inner tube.

6. The capless writing tool according to claim 1, wherein a window hole is formed in a front portion of said barrel or in a front piece so as to prevent abutment of said lid against the front portion of the barrel or the front piece when the lid is opened or closed.

7. The capless writing tool according to claim 1, wherein said inner tube is retreated together with said refill by engagement of a retaining lug formed on the refill with a rib formed on an inner wall of the inner tube.

8. The capless writing tool according to claim 1, wherein said lid for opening and closing the front opening of said inner tube is provided with a retaining projection having a retaining pawl, said retaining projection, in an open condition of the opening of said inner tube, being engaged with a front side of a retaining portion formed on a side face of the barrel or the front piece.

9. The capless writing tool according to claim 1, wherein said lid for opening and closing the front opening of said inner tube is provided with a retaining projection having a retaining pawl, said retaining pawl, in a closed condition of the opening of said inner tube, being engaged with a rear side of a retaining portion formed on a side face of the barrel or the front piece.
